(19) United States
(12) Patent Application Publication
(10) Pub. No.: US 2026/0355041 A1
(43) Pub. Date: Nov. 12, 2026

(54) ATTACHMENT DEVICE FOR USE IN EXOSKELETON SYSTEMS

(71) Applicant: OZYEGIN UNIVERSITESI, Istanbul (TR)

(72) Inventors: Suleyman Can CEVIK, Istanbul (TR); Ozkan BEBEK, Istanbul (TR); Regaip Barkan UGURLU, Istanbul (TR)

(73) Assignee: OZYEGIN UNIVERSITESI, Istanbul (TR)

(21) Appl. No.: 19/134,760

(22) PCT Filed: Dec. 29, 2022
(86) PCT No.: PCT/TR2022/051672

§ 371 Date: Jun. 2, 2025

(30) Foreign Application Priority Data
Dec. 15, 2022 (TR) 2022/019388

(51) Int. Cl. A61H 3/00

(52) U.S. Cl. CPC A61H 3/00; A61H 2003/007; A61H 2201/0173; A61H 2201/165

(57) ABSTRACT

An attachment device for enabling safe human connection in wearable exoskeleton systems comprises at least one carrier part that can be detachably connected to the exoskeleton system in case of sudden load, and at least one holding member for at least partially gripping the human limb on the carrier part.

### CROSS REFERENCE TO RELATED APPLICATIONS

This application is a national stage entry of International Application No. PCT/TR2022/051672, filed on Dec. 29, 2022, which is based upon and claims foreign priority to Turkey Patent Application No. TR2022/019388, filed on Dec. 15, 2022, the entire contents of which are incorporated herein by reference.

### TECHNICAL FIELD

The present invention relates to at least one attachment device for enabling safe human connection in wearable exoskeleton systems.

### BACKGROUND

Wearable skeletal technologies support the prevention of musculoskeletal disorders by minimizing the strains on the skeletal system by means of supporting the skeletal system and reducing the power consumed for the work done. Most people have jobs that require them to use their body skills in labor-intensive work like welding and heavy lifting. Likewise, body movements are important in rehabilitation treatments.

Application No. US2019291285, which is in the state of the art, relates to the devices that increase the carrying capacity, strength, and performance of the user and help prevent injury during the performance of certain lifting and strength-requiring tasks. The said device has a locking mechanism to lock onto the person safely, and a spring mechanism to enable its movement on the person.

Application No. US2015351995, which is in the state of the art, relates to a lower extremity exoskeleton configured to be attached to a person with right and left flank body abilities. Said exoskeleton is used to support the lower part of a patient's body and has a locking system for safe placement on the patient's body.

Application No. US20150351995, which is in the state of the art, relates to a method for controlling the lower extremity exoskeleton, wherein each said leg support is configured to rest on the ground during a stance phase and includes a thigh attachment and a body attachment connected with a knee joint, and an asymmetrically configured or controlled exoskeleton body to be attached to the person's upper body and rotatably attached to each of them.

In the prior art, there is no description for locking the exoskeleton system and the human for the purpose of safety. In the prior art, there is no solution to prevent dangerous or harmful situations that may occur during the use of the designed attachments and exoskeletons. A solution for the problems of paraplegic patients without any help or using an assistive device is not available in the prior art. There are precautions taken against accidents, bumps, and falls in the literature, but exoskeletons in the market or patents do not have a system to separate the user from the exoskeleton when necessary.

As a result, all the above-mentioned disadvantages have made it necessary to make an innovation in the relevant technical field.

### SUMMARY

The present invention relates to an attachment device for eliminating the above-mentioned disadvantages and bringing new advantages to the related technical field.

An object of the invention is to provide an attachment device for use in exoskeleton systems.

Another object of the invention is to provide an attachment device in which the dangerous or harmful situations that may occur during the use of exoskeletons are reduced by separating the connection between the human and the robot.

In order to achieve all the above-mentioned objects which will emerge from the detailed explanation below, the present invention is at least one attachment device to allow safe human connection in wearable exoskeleton systems. Accordingly, its novelty is that it comprises at least one carrier part that can be detachably connected with the exoskeleton system in case of sudden load and at least one holding member for at least partially gripping the human limb on the said carrier part. Thus, in case of sudden load, the person is separated from the exoskeleton system by means of the attachment device.

A possible embodiment of the invention is characterized in that it comprises at least one pushing unit for rapid removal of the carrier part from the exoskeleton system. Thus, the separation of the attachment device from the exoskeleton system is accelerated.

Another possible embodiment of the invention is characterized in that the said pushing unit comprises at least one spring and at least one latch. Thus, the potential energy accumulated in the spring is transferred to the attachment device.

Another possible embodiment of the invention is characterized in that it comprises at least one first lock member on the exoskeleton system and at least one second lock member on the carrier part in order to detachably connect the carrier part to the exoskeleton system. Thus, assembly and disassembly of the attachment device can be performed on the exoskeleton system.

Another possible embodiment of the invention is characterized in that it comprises at least one first rod and at least one second rod between the said holding member and carrier part. Thus, it is ensured that the holding member is positioned in accordance with the human limb.

Another possible embodiment of the invention is characterized in that the first rod is positioned to be movable at least partially in the extension direction of the carrier part. In this way, individual configuration of the attachment device is ensured.

Another possible embodiment of the invention is characterized in that the said second rod comprises at least one first adjustment unit for adjusting the position on the first rod. In this way, individual configuration of the attachment device is ensured.

Another possible embodiment of the invention is characterized in that the holding member comprises at least one second adjustment unit for adjusting the position on the second rod. In this way, individual configuration of the attachment device is ensured.

### BRIEF DESCRIPTION OF THE DRAWINGS

FIG. 1 shows a representative perspective view of the exoskeleton system on which the attachment device of the invention is positioned.

FIG. 2 shows a representative perspective view of the attachment device of the invention.

### REFERENCES IN THE FIGURES

10 Attachment Device
20 Body
21 Supporting Member
22 First Lock Member
30 Carrier Part
31 Second Lock Member
32 Pushing Unit
33 Latch
34 Spring
35 First Rod
36 Second Rod
37 Holding Member
38 First Adjustment Unit
39 Second Adjustment Unit
40 Exoskeleton System

### DETAILED DESCRIPTION OF THE EMBODIMENTS

In this detailed description, the subject matter of the invention is explained only by means of examples that will not have any limiting effect for a better understanding of the subject matter.

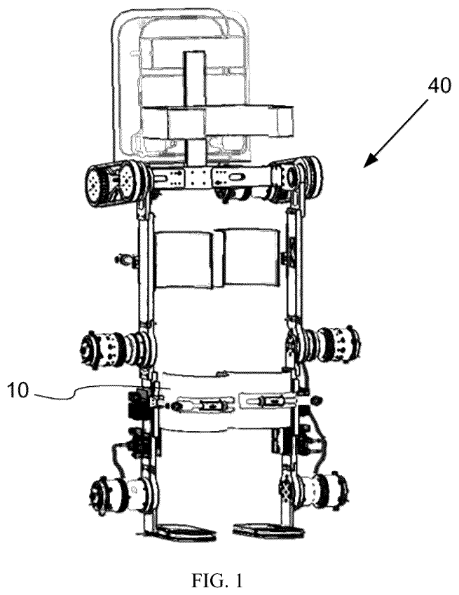

FIG. 1 shows a representative perspective view of the exoskeleton system (40) on which the attachment device (10) of the invention is positioned. Accordingly, the attachment device (10) subject to the invention is positioned on an exoskeleton system (40). Said exoskeleton system (40) is a device that helps the movement functions together with the person wearing it. The exoskeleton system (40) provides robot-assisted walking support for patients with paraplegic and lower extremity motor function problems who suffer from spinal cord injury.

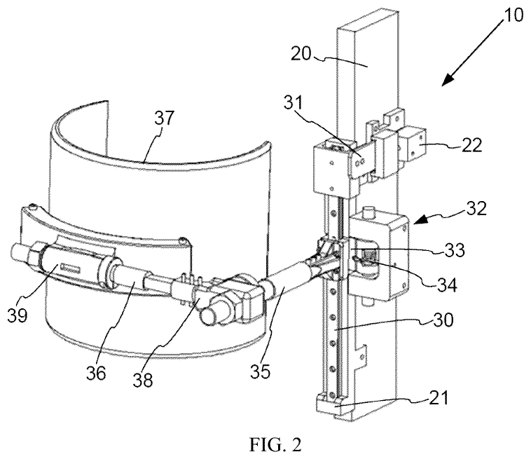

FIG. 2 shows a representative perspective view of the attachment device (10) of the invention. Accordingly, it is aimed to reduce the dangerous or harmful situations that may occur between the attachment device (10), the exoskeleton system (40), and the human during the use of the exoskeleton system (40), by separating the connection between the human and the robot. Rehabilitation robots and human use can be counted among the usage areas of the attachment device (10).

The attachment device (10) has at least one body (20). Said body (20) can be in the form of a connection part fixed on the exoskeleton system (40). There is at least one supporting member (21) on the body (20). There is at least one carrier part (30) on the said supporting member (21). The said carrier part (30) is connected to the body (20) in a detachable manner. In order to allow this, the carrier part (30) is positioned on the supporting member (21) on one side and locked onto the body (20) on the other side.

There is at least one second lock member (31) on at least one of the carrier part (30) and the body (20) and at least one first lock member (22) on the other in order to ensure that the carrier part (30) is locked on the body (20). Preferably, the second lock member (31) is positioned on the carrier part (30). The second lock member (31) is mainly positioned on the body (20) and especially on the upper part of the body (20). The second lock member (31) is essentially in the form of a buckle. The first lock member (22) can be a solenoid actuator to hold the second lock member (31) in the form of a buckle. Depending on the triggering of the first lock member (22) in the form of a solenoid actuator, the second lock member (31) can be released. The triggering of the first lock member (22) can be performed by a control unit or by the user's triggering.

There is at least one pushing unit (32) in the attachment device (10) for separating the carrier part (30) on the body (20) from the body (20). Said pushing unit (32) allows the carrier part (30) released from the body (20) to be quickly removed. For this purpose, the pushing unit (32) essentially has a mechanical substructure. There is at least one latch (33) and at least one spring (34) in the pushing unit (32). While the spring (34) is fixed on the body (20) on one side, it is positioned so that it can apply a pushing force to the carrier part (30) on the other side. For this purpose, there is said latch (33) between the spring (34) and the carrier part (30). The latch (33) applies a pushing force to the carrier part (30) by rotating it at least partially around itself. For this purpose, the latch (33) is configured to be at least partially rotatable. By means of the pushing unit (32), both the rapid removal of the carrier part (30) from the body (20) is ensured and the gap-free position of the carrier part (30) while it is positioned on the body (20) is supported.

There is at least one first rod (35) on the carrier part (30) and at least one second rod (36) to which said first rod (35) is connected. Said first rod (35) is positioned to be movable at least partially in the extension direction of the carrier part (30). In this way, the positioning adjustment is made in accordance with the body of the person on which the exoskeleton system (40) is positioned. Likewise, the second rod (36) is configured to be movable on the first rod (35). For this purpose, there is at least one first adjustment unit (38) between the first rod (35) and the second rod (36). Said first adjustment unit (38) provides position adjustment of the second rod (36) relative to the first rod (35). There is at least one holding member (37) on the second rod (36). Said holding member (37) has the form of a half-moon so as to at least partially grip the body limb of the person. The holding member (37) is configured to be at least partially slidable on the second rod (36). For this purpose, there is at least one second adjustment unit (39) between the second rod (36) and the holding member (37). By means of the said second adjustment unit (39), an adaptable structure is obtained for people of different sizes.

In a possible embodiment of the invention, after the person wears the exoskeleton system (40) on his/her body, the attachment device (10) is placed to support the person's calf. During this process, the second lock member (31) is attached to the first lock member (22), and the attachment device (10) is fixed on the exoskeleton system (40). Subsequently, in case of sudden force overloads that may occur during the use of the exoskeleton system (40), the control unit detects the unusual force overload and ensures that the first lock member (22) releases the second lock member (31). At the same time, the user will be able to activate the system himself/herself in an undesirable situation with a remote control, button or any trigger to be used by the user. Along with all this configuration, human safety is increased by detecting the unusual load on the person (the possibility of harming the person with the fall of the person or the sudden movement of the motors) in the exoskeleton systems (40). Besides, especially without any help or using an auxiliary tool, a solution is provided to the problems of paraplegic patients.

The protection scope of the invention is specified in the appended claims and certainly cannot be limited to what has been described in this detailed description for illustrative purposes. It is clear that those skilled in the art can produce similar embodiments in light of the foregoing without departing from the main theme of the invention.

1. An attachment device to allow safe human connection in wearable exoskeleton systems, comprising at least one carrier part that can be detachably connected with the exoskeleton system in case of sudden load, and at least one holding member for at least partially gripping the human limb on the carrier part.

2. The attachment device according to claim 1, further comprising at least one pushing unit in order to quickly remove the carrier part from the exoskeleton system.

3. The attachment device according to claim 2, wherein the pushing unit comprises at least one spring and at least one latch.

4. The attachment device according to claim 1, further comprising at least one first lock member on the exoskeleton system and at least one second lock member on the carrier part in order to detachably connect the carrier part to the exoskeleton system.

5. The attachment device according to claim 1, further comprising at least one first rod and at least one second rod between the holding member and carrier part.

6. The attachment device according to claim 5, wherein the first rod is at least partially movably positioned in the extending direction of the carrier part.

7. The attachment device according to claim 5, wherein the second rod comprises at least one first adjustment unit for adjusting the position on the first rod.

8. The attachment device according to claim 5, wherein the holding member comprises at least one second adjustment unit for adjusting the position on the second rod.
